(19) United States
(12) Patent Application Publication
(10) Pub. No.: US 2022/0117198 A1
(43) Pub. Date: Apr. 21, 2022

(54) INTERACTIVE DOG TOY

(71) Applicant: Worldwise, Inc., Novato, CA (US)

(72) Inventor: Allen Grainer, Denver, CO (US)

(21) Appl. No.: 17/506,467

(22) Filed: Oct. 20, 2021

Related U.S. Application Data
(60) Provisional application No. 63/093,942, filed on Oct. 20, 2020.

(51) Int. Cl. A01K 15/02

(52) U.S. Cl. CPC A01K 15/025

(57) ABSTRACT

A pet toy featuring an outer shell defining a shape of the toy and a deformable bladder and at least one sleeve in fluid communication with each other retained within said outer shell. The sleeve extends within a segment of the toy and has a region configured to bend from a first orientation wherein said bladder is in a first state to a second orientation wherein said bladder is in a second state. The sleeve transitions as a result of pressure being applied to the bladder because fluid transfers from the bladder to the sleeve. The sleeve transitions back upon the removal of pressure from the bladder. The bending region of the sleeve is molded to assume the first orientation, such as by heat treatment.

### CROSS-REFERENCE TO RELATED APPLICATIONS

This application claims priority from and benefit of U.S. Provisional Patent Application Ser. No. 63/093,942, filed Oct. 20, 2020, which is entitled “Interactive Dog Toy,” is assigned to the assignee hereof, and is incorporated by reference in its entirety.

### TECHNICAL FIELD OF THE INVENTION

The present invention involves an interactive dog toy that is capable of enhancing a pet's interest in the toy by encouraging the pet to engage its natural instinct to bite and chew. The toy includes a deformable bladder and unique sleeve that facilitates actuating a component of the toy, activation resulting from the transfer of air between the bladder and sleeve. Moreover, these techniques can be extended to other product categories, including toys and novelty items intended for humans.

### BACKGROUND OF THE INVENTION

It is well-known that dogs need to bite and chew for a variety of reasons. These are natural tendencies which characterize a healthy, normal canine. Pet owners in recognizing these natural instincts generally provide their pets with chew toys to prevent them from biting and chewing upon furniture and other household items. Not surprisingly, there are a myriad of chew toys currently available which include ropes, molded rubber and plastics, as well as plush replicas of rodents and other like animals.

Recognizing that the goal in providing a chew toy is to ensure, to the extent possible, that the dog focuses its need to bite and chew upon the toy to the exclusion of furniture, pillows and other household items, various attempts have been made to enhance the attractiveness of the toy to the pet. For example, various rubber molded chew toys include cavities for the receipt of treats which the pet would strive to access. As it pertains to plush chew toys, there have been suggestions that various appendages can be caused to move in response to biting pressure being applied to the toy. Toys of this type have been disclosed in, for example, U.S. Pat. Nos. 6,881,119 and 6,672,932.

As an illustration, reference is made to FIGS. 1A-1D. This plush toy 10, in the form of rabbit head 11 would contain a deformable bladder in fluid communication with one or more sleeves which extend into ears 13 and 14. As the region of head 11 is thickest in area 12, a deformable bladder would be placed in that region encouraging the pet to bite down upon head 11 in region 12 which would transfer fluid (air) to sleeves extending within ears 13 and 14. As biting pressure is applied by the dog, the ears would move in the direction of arrows 15 and 16. It is been found that the movement of ears 13 and 14 would enhance the interest of the pet to plush toy 10 as intended. In a properly constructed plush toy, ears 13 and 14 would drop from that configuration depicted in FIG. 1D to their original orientation shown in FIG. 1A as the dog removes biting pressure from area 12.

Unfortunately, toys such as that depicted in FIGS. 1A-1D do not consistently operate as intended. Fluid transfer between the enclosed bladder and sleeves, particularly after multiple use, does not always extend the appendages as depicted in the figures and, again, after continued use, the appendages do not consistently return to their original FIG. 1A orientation.

It is thus an object of the present invention to provide an interactive pet toy which improves upon those pet toys currently available.

It is still a further object of the present invention to provide an interactive pet toy which contains a bladder/sleeve fluid transfer arrangement which will perform as intended after multiple and continued use by an active pet.

These and further objects will be more readily appreciated when considering the following disclosure and appended figures.

### SUMMARY OF THE INVENTION

In a pet toy comprising a deformable outer shell defining the shape of the toy and retained within said outer shell, a deformable bladder and at least one sleeve, said bladder and said at least one sleeve being in fluid communication with one another, and wherein said at least one sleeve extends within a segment of the toy, said at least one sleeve having a region capable of bending from a first orientation wherein said bladder is in a first state to a second orientation wherein said bladder is in a second state, transitioning from said first state to said second state being the result of pressure being applied to said bladder further resulting in fluid transfer from said bladder to said at least one sleeve, transitioning from said second state to said first state upon the removal of pressure from said bladder resulting in fluid transfer from said at least one sleeve to said bladder, and an improvement comprising molding said at least one sleeve over a bending region in the first orientation.

In a pet toy comprising a deformable outer shell defining the shape of the toy and retained within said outer shell, a deformable bladder and at least one sleeve, said bladder and said at least one sleeve being in fluid communication with one another, and wherein said at least one sleeve extends within a segment of the toy, said at least one sleeve having a region capable of bending from a first orientation wherein said bladder is in a first state to a second orientation wherein said bladder is in a second state, transitioning from said first state to said second state being the result of pressure being applied to said bladder further resulting in fluid transfer from said bladder to said at least one sleeve, transitioning from said second state to said first state upon the removal of pressure from said bladder resulting in fluid transfer from said at least one sleeve to said bladder, and an improvement comprising an elastic strap applied to said outer shell in said region and which resists movement from said first orientation to said second orientation.

In a pet toy comprising a deformable outer shell defining the shape of the toy and retained within said outer shell, a deformable bladder and at least one sleeve, said bladder and said at least one sleeve being in fluid communication with one another, and wherein said at least one sleeve extends within a segment of the toy, said at least one sleeve having a region capable of bending from a first orientation wherein said bladder is in a first state to a second orientation wherein said bladder is in a second state, transitioning from said first state to said second state being the result of pressure being applied to said bladder further resulting in fluid transfer from said bladder to said at least one sleeve, transitioning from said second state to said first state upon the removal of pressure from said bladder resulting in fluid transfer from said at least one sleeve to said bladder, and an improvement comprising a plurality of ribs extending along said at least one sleeve in said region.

### BRIEF DESCRIPTION OF THE DRAWINGS

FIGS. 1A-1D are front views of a typical plush chew toy for embodying the interactive elements of the present invention.

FIGS. 2A-2C are perspective views of the interactive elements of the present invention.

FIG. 3 is a front view of a sleeve constituting an interactive element of the present invention.

FIG. 4 is a side view of the sleeve of FIG. 3.

FIG. 5 is a cross-sectional view of a sleeve constituting an interactive element of the present invention in a first (bent) orientation.

FIG. 6 is a cross-sectional perspective view of a sleeve constituting an interactive element of the present invention within a segment of a plush chew toy.

FIG. 7 is a side cross-sectional view of the sleeve constituting an interactive element of the present invention within a segment of a plush chew toy.

FIGS. 8A & 8B are side views illustrating the application of a suitable deformable strap to the outer shell of a plush toy as constituting an embodiment of the present invention.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

Although canine chew toys which include embedded bladders causing various appendages of the toy to move in response to biting pressure applied to the toy are well known, all such iterations of which applicant is aware suffer from their inability to satisfactorily actuate upon repeated use. As a result, such toys tend not to engage and maintain the dog's interest over time and become simply another plush toy soon to be ignored.

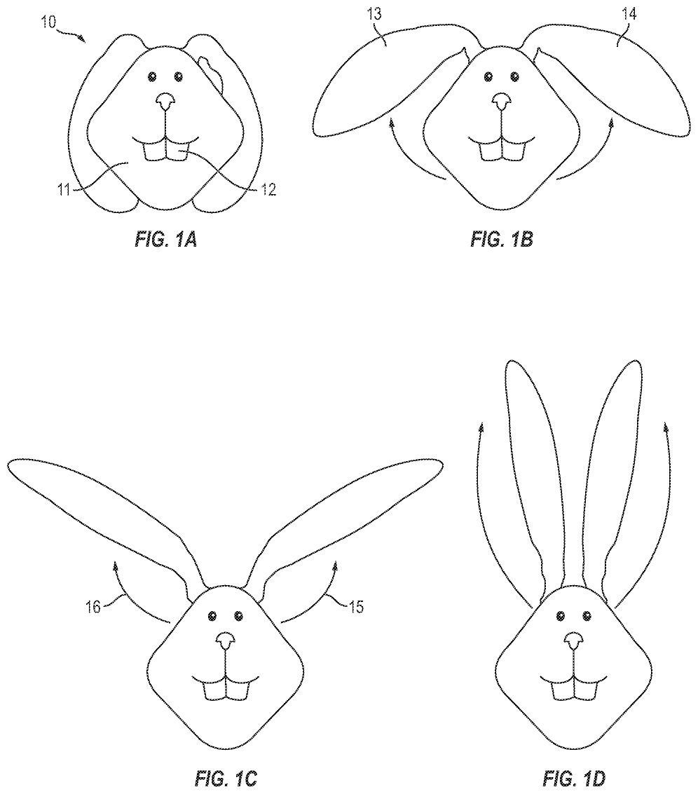

As previously discussed, plush toy 10 is an example of a toy intended for a pet dog that stimulates the pet's interest and minimizes boredom by enabling segments such as appended ears 13 and 14 to move from their at rest position (FIG. 1A) through progressive articulations (FIGS. 1B and 1C) to their fully extended position (FIG. 1D) and back again by applying and removing biting pressure upon the body of the pet toy in area 12. To the extent similar toys exist in the prior art, although they appear similar in outward appearance, they do not utilize the internal constructions detailed in this disclosure and as a result, suffer from a lack of durability and reproducibility of the desired motion. Accordingly, the following materials describe these improved internal configurations.

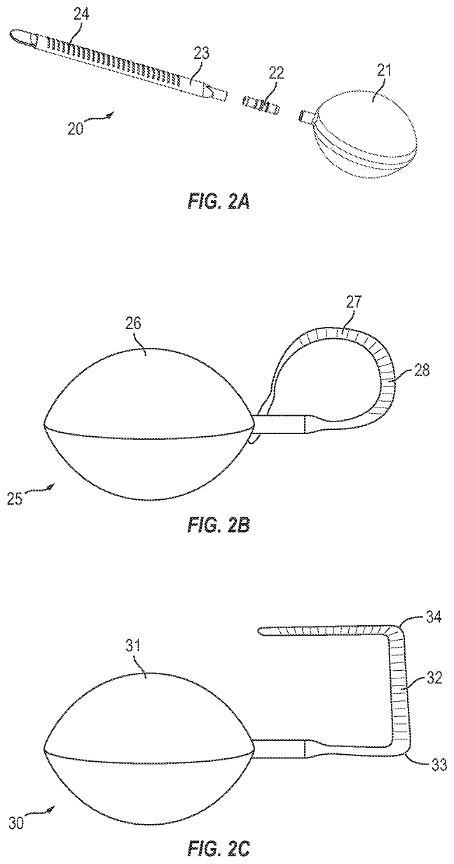

Situated within the body of the chew toy, such as in area 12, is placed deformable bladder 21 connected to sleeve 24 as shown by composite 20 (FIG. 2A). Bladder 21 is appended to sleeve 24 via connector 22. In some embodiments, connector 22 also includes a reed or other suitable “squeaker” mechanism to create a complementary noise when the bladders are deformed. Similar functionality can be obtained by locating the squeaker at other positions within the system. Although the illustrations of FIG. 2 depict singular sleeves 24, 27 and 32 appended from bladders 21, 26 and 31, respectively, multiple sleeves are contemplated when used in conjunction with chew toys such as that illustrated in FIG. 1 for separate sleeves are to extend within segments (ears) for appropriate actuation. In one embodiment, a suitable material for the sleeves and bladder is ethylene-vinyl actetate (EVA) copolymer resin, such as EVATHENE® UE630. Important characteristics for the sleeves and bladder are high flexibility and elasticity at room temperature, providing the ability to extend and pull back, low melting point to facilitate the heat molding process described below to re-shape the sleeve into curve or other bent configuration as warranted by the different toy designs and great resistance to external stress to avoid cracking during blow molding and re-shaping. Other polymers and materials having similar characteristics may also be used. In one embodiment, a suitable material for the connectors is polyoxymethylene (POM), also known as acetal, polyacetal, and polyformaldehyde, which is an engineering thermoplastic used in precision parts requiring high stiffness, low friction, and excellent dimensional stability. Again, other polymers and materials having similar characteristics may also be used. Further, as indicated for example by bladder 21, some embodiments feature a bladder that is pillow-shaped, having two halves joined around their perimeter to function as a hinge, rather than a spherical or ball-shaped bladder. Such configurations may facilitate the compression of the bladder when bit or otherwise squeezed by the pet to increase the volume of fluid expelled from the bladder which in turn results in more reliable actuation of the sleeves.

In again referring to FIG. 2, it is noted that sleeve 24 can be molded to create nonlinear shapes such as circular shape 28 (FIG. 2B) and orthogonal bends 33 and 34 (FIG. 2C). As bladders 26 and 31 of examples 25 and 30 are depressed, fluid (air) is transferred to sleeves 27 and 32 causing them to change geometries which would, in turn, move the respective toy segments to which these sleeves are applied.

In providing sleeves which operate more effectively than those of the prior art, it is contemplated that molded ribs 24 are formed within sleeve 23 which assists in controlling the direction of bending of the sleeves, such as by being oriented orthogonally to the deflection associated with the first or bent orientation before fluid is transferred into the sleeves. In this regard, similar ribs are shown in sleeves 27 and 32 of FIGS. 2B and 2C.

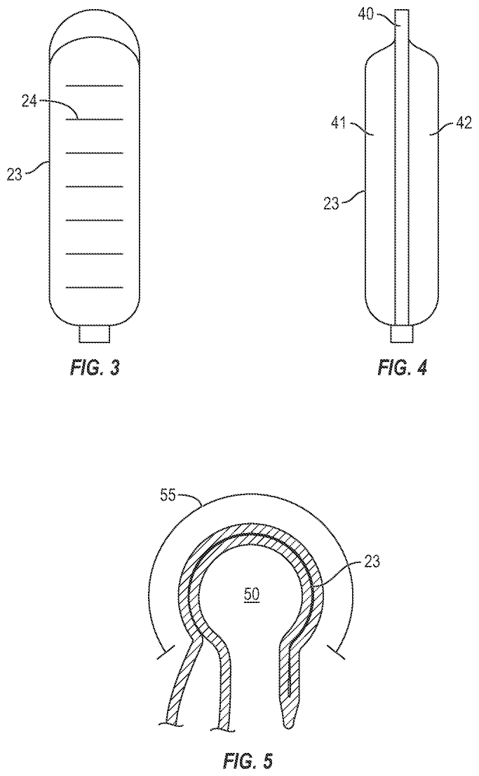

Upon molding sleeve 23, a further improvement over pre-existing sleeves of the prior art is realized by ensuring that molded mating halves 41 and 42 as shown in FIGS. 3 and 4 are evenly spaced on both sides of center mold seam 40. In doing so, when sleeve 23 is heat molded into the bent configuration such as over a die, the bending region 55 as shown in FIG. 5 occupies a substantial portion of sleeve 23, increasing the amount of fluid (air) exchanged with bladder 21, 26 or 31 when transitioning between the extended and bent configuration. Desirably, exchanging a greater amount of fluid can make the transition more reliable and repeatable. Likewise, the heat molding also desirably causes molded halves 41 and 42 to conform closely to each other in the bent configuration, such as by being adjacent or in contact with each other, causing more fluid to be returned to bladder 26 or 31 for subsequent activation. As one illustration, the bent configuration of sleeve(s) 23 corresponds to a first orientation such as that shown in FIGS. 2B and 2C where ears 11 and 12 flop against the head of plush toy 10 and the extended configuration when sleeve(s) 23 are inflated with fluid corresponds to their more linear orientation causing ears 11 and 12 to extend (FIG. 1D). Transitioning from this first state to second state being the result of pressure being applied to bladders 26 and 31. In one embodiment, a suitable heat molding process includes fixing sleeve 23 on a specified size metal tool or die having the desired bend characteristics, immersing the metal tool and sleeve in a heated water bath (such as, for example, 90° F.) to allow the plastic sleeve to reform to the shape imparted by the metal tool and subsequently quenching in a cold water bath to cool the material and fix the imparted shape. Water is a suitable media for heat transfer, but other stable environments capable of even heat transfer may also be used.

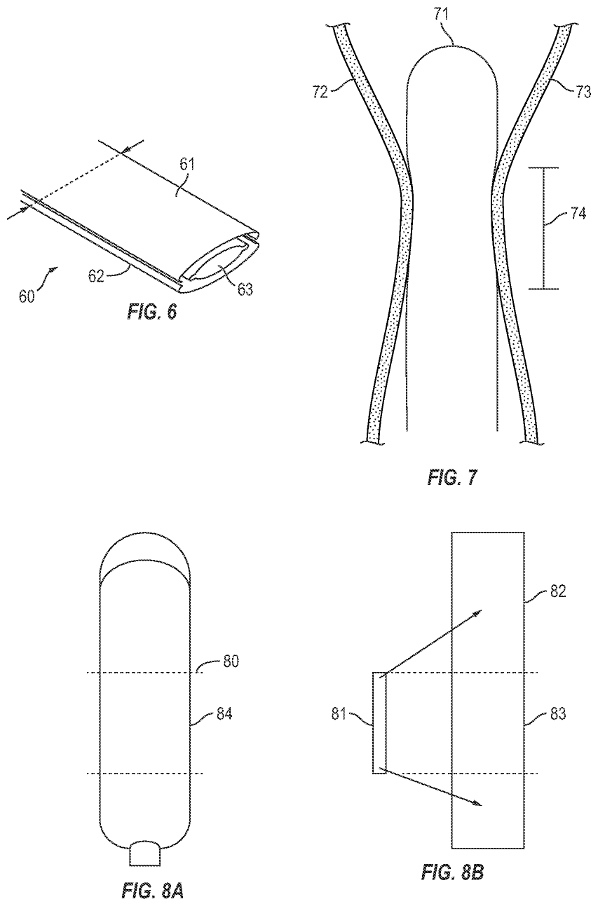

In turning to FIGS. 6 and 7, sleeve 63 is shown as applied to segment 60 composed of fabric halves 61 and 62. As noted, sleeve 63 is symmetrically fitted within halves 61 and 62 which creates the appropriate and desired movement of segment 61 upon actuation. Further optimization of the present actuating mechanism is achieved by ensuring a tight fit of segment fabric 72 and 73 upon sleeves 71 particularly within bend area 74 so as to frictionally engage sleeve 71. Desirably, the fit between the fabric and sleeves reduces migration of sleeve 23 so that its change in conformation when inflated reliably corresponds to movement of the intended portions of the toy.

Reference is next made to FIGS. 8A and 8B. As previously noted, in order to optimize the present invention, as bite pressure is released from the plush toy, such as in area 12, fully extended ears as depicted in FIG. 1D must return to their at rest, non-actuated orientation of FIG. 1A. Although release of bite pressure upon the toy's embedded bladder will cause the various segments to somewhat return to their at rest position as a result of the heat molding of sleeves 23 noted above, to further encourage this desired effect, an elastic member such as strap 81 is applied to plush fabric 82 into which sleeve 80 has been encased. Strap 81 is applied over fabric segment 83 which is intended to bend as segment 84 of sleeve 80 bends and secured to segment. Elastic strap 81 resists movement from a first orientation where the bladder is in a first state wherein no external pressure is applied to it (FIG. 1A) to its second state where fluid contained within the bladder is transferred to the sleeves (FIG. 1D). Thus, when biting pressure is removed from the plush toy, the biasing of elastic strap 81 encourages the toy segments to return to their at rest orientation. In one embodiment, elastic strap 81 may be oriented in line with the intended direction of bending and spans a sufficient portion of the bending region so that sleeve 23 returns to the desired relaxed orientation. One or more elastic straps 81 may be employed depending on the intended motion.

Further, in order to minimize degradation of the plush toy, its outer shell may be composed of a polyester mesh pad applied to the inner surface of the plush outer fabric that forms the outer perimeter of the toy. The polyester mesh pad is applied to the inner surface of the plush shell fabric by employing a non-toxic low-tack gel adhesive to provide the sought after wear resistance while not adversely affecting the ability of the shell fabric to react appropriately to pressure applied to it by the engaged canine. Typically, the polyester mesh is characterized as being approximately 3 mm in thickness, having a weight of approximate 150 g/m². The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. For example, the toy can represent any real or imaginary figure such as animals, characters or other objects. Therefore, the above description and illustration should not be considered as limiting the scope of the invention, which is defined by the appended claims.

1. A pet toy comprising:
a deformable outer shell defining a shape of the toy; and
a deformable bladder and at least one sleeve retained within said outer shell, said bladder and said at least one sleeve being in fluid communication with one another, wherein:
said at least one sleeve extends within a segment of the toy;
said at least one sleeve having a region configured to bend from a first orientation wherein said bladder is in a first state to a second orientation wherein said bladder is in a second state,
transitioning from said first state to said second state being the result of pressure being applied to said bladder further resulting in fluid transfer from said bladder to said at least one sleeve, transitioning from said second state to said first state upon the removal of pressure from said bladder resulting in fluid transfer from said at least one sleeve to said bladder; and
said bending region of said at least one sleeve is molded to assume said first orientation.

2. The pet toy of claim 1, wherein said molded bending region is heat treated.

3. The pet toy of claim 1, wherein said heat treatment comprises placing said at least one sleeve on a die and submerging the die in a water bath.

4. The pet toy of claim 1, wherein said molded bending region comprises mating halves joined at a center seam.

5. The pet toy of claim 4, wherein said mating halves conform closely to each other when assuming said first orientation.

6. The pet toy of claim 1, wherein said molded bending region comprises a plurality of ribs configured to facilitate assuming said first orientation.

7. The pet toy of claim 1, wherein said plurality of ribs are oriented orthogonally with respect to a bend direction associated with said first orientation.

8. The pet toy of claim 1, wherein said at least one sleeve is disposed within a fabric segment.

9. The pet toy of claim 8, wherein the fabric segment comprises two halves joined at their edges and wherein said at least one sleeve is symmetrically positioned with respect to said two halves.

10. The pet toy of claim 8, wherein said fabric segment engages said at least one sleeve at said molded bending region.

11. The pet toy of claim 1, wherein said fabric segment further comprises an elastic member secured to regions of said fabric segment adjacent said molded bending region.

12. The pet toy of claim 11, wherein said elastic member biases said at least one sleeve to the first orientation.

13. A method for constructing an interactive pet toy, comprising:
molding a bending region in at least one sleeve to assume said first orientation;
providing a fluid connection between said at least one sleeve and a deformable bladder;
disposing said deformable bladder and said at least one sleeve within a deformable outer shell defining a shape of the toy, wherein said at least one sleeve extends within a segment of the toy, such that said at least one sleeve is configured to:
bend from said first orientation wherein said bladder is in a first state to a second orientation wherein said bladder is in a second state;
transition from said first state to said second state as a result of pressure being applied to said bladder and consequent fluid transfer from said bladder to said at least one sleeve; and
transition from said second state to said first state upon the removal of pressure from said bladder resulting in fluid transfer from said at least one sleeve to said bladder.

14. The method of claim 13, wherein molding said bending region comprises a heat treatment.

15. The method of claim 14, wherein said heat treatment comprises placing said at least one sleeve on a die and submerging the die in a water bath.

16. The method of claim 13, further comprising providing said molded bending region with a plurality of ribs.

17. The method of claim 13, further comprising disposing said at least one sleeve is disposed within a fabric segment.

18. The method of claim 17, further comprising securing an elastic member to regions of said fabric segment adjacent said molded bending region.
